(19) United States
(12) Patent Application Publication
(10) Pub. No.: US 2026/0057810 A1
(43) Pub. Date: Feb. 26, 2026

(54) MACHINE INDICATOR LIGHT WITH BUILT-IN STATUS MESSAGE

(71) Applicant: Banner Engineering Corp., Minneapolis, MN (US)

(72) Inventor: Charles Dolezalek, Blaine, MN (US)

(73) Assignee: Banner Engineering Corp., Minneapolis, MN (US)

(21) Appl. No.: 18/895,154

(22) Filed: Sep. 24, 2024

Related U.S. Application Data
(63) Continuation-in-part of application No. PCT/US2023/072281, filed on Aug. 16, 2023.
(60) Provisional application No. 63/371,594, filed on Aug. 16, 2022.

(51) Int. Cl. G09F 13/00; G09F 13/04

(52) U.S. Cl. CPC G09F 13/005; G09F 13/0418

(57) ABSTRACT

Apparatus and associated methods relate to a light device with a programmable display. In an illustrative example, a linear multi-mode programmable indicator light (LMPIL) may include a housing extending along a longitudinal axis having a display surface. For example, the LMPIL may include an indicator light, and a programmable display coupled to the housing. For example, the indicator light may emit a light indicium orthogonal to the display surface. For example, the programmable display may display a predetermined visual indicium along a longitudinal axis through the display surface when the indicator light emits the light indicium. For example, based on predetermined associations between light indicia and corresponding predetermined visual indicia, the programmable display may display the predetermined visual indicium as the corresponding predetermined interpretation of the light indicium based on the predetermined associations. Various embodiments may advantageously display preconfigured messages with corresponding light indicia on any visible surface.

### CROSS-REFERENCE TO RELATED APPLICATIONS

This application is a continuation-in-part of International Application Serial No. PCT/US2023/072281, titled “Machine Indicator Light with Build-in Status Message,” filed by Charles Dolezalek, on Aug. 16, 2022, which claims the benefit of U.S. Provisional Application Ser. No. 63/371,594, titled “Machine Indicator Light with Build-in Status Message,” filed by Charles Dolezalek, on Aug. 16, 2022.

This application incorporates the entire contents of the foregoing application(s) herein by reference.

The subject matter of this application may have common inventorship with and/or may be related to the subject matter of the following:
U.S. Provisional Application Ser. No. 63/483,476, titled “Body-Registering Unified Circuit In-Line Touch Switch,” filed by Charles Dolezalek, et al., on Feb. 6, 2023.
International Design application Ser. No. 35/003,350, issued with International Registration No. DM/233724, titled “In-Line Touch Module,” filed by Charles Dolezalek, et al., on Jan. 13, 2023.
U.S. Provisional Application Ser. No. 63/377,301, titled “Reconfigurable Detection Windows with Dynamically Activated Detection Arrays,” filed by Charles Dolezalek, et al., on Sep. 27, 2022.
U.S. Design Pat. No. DM/222908, titled “Communication Hub Offset Standoff Bracket,” filed by Robert T. Fayfield, et al., on Apr. 22, 2022, issued on Apr. 21, 2023.
PCT Application Serial No. PCT/US2022/078548, titled “Distributed Communication System Using Concurrent Multi-Channel Master Unit,” filed by Robert T. Fayfield, et al., on Oct. 21, 2022.
PCT Application Serial No. PCT/US2022/075677, titled “Field Installable Light Curtain Side Status Module,” filed by Nick Olsen, et al., on Aug. 30, 2022.
U.S. application Ser. No. 17/823,312, titled “Field Installable Light Curtain Side Status Module,” filed by Nick Olsen, et al., on Aug. 30, 2022.
PCT Application Serial No. PCT/US2022/00108, titled “Distance Sensing and Visual Indicator Arrays with Reconfigurable Detection Windows,” filed by Charles Dolezalek, on Jan. 10, 2022.
U.S. application Ser. No. 17/153,691, titled “Distance Sensing and Visual Indicator Arrays with Reconfigurable Detection Windows,” filed by Charles Dolezalek, on Jan. 20, 2022.
U.S. application Ser. No. 15/222,429, titled “Omni-Directional In-Line Indicator Device,” filed by Charles Dolezalek, et al., on Jul. 28, 2016, issued as U.S. Pat. No. 10,347,092 on Jul. 9, 2019.
U.S. application Ser. No. 17/935,763, titled “radio Permissive Impact Absorbing Unitary Cover,” by Dolezalek, et al., on Sep. 27, 2022.
U.S. application Ser. No. 15/254,564, titled “IMPACT ABSORBING UNITARY COVER ASSEMBLY” and filed Sep. 1, 2016, by Dolezalek, et al., issued as U.S. Pat. No. 9,984,835 on May 29, 2018.

This application incorporates the entire contents of the foregoing application(s) herein by reference.

### TECHNICAL FIELD

Various embodiments relate generally to configurable visual indicators.

### BACKGROUND

Single and multi-color indicators have been used for decades to signify machine or process status. Typically, colors of an indicator may convey a predetermined meaning (e.g., machine or process status) to alert workers, machine operators, and/or supervisor. For example, a typical stack light may be used with a standard for the meaning of each color. For example, according to the standard, red light may mean an emergency status, amber light may mean an abnormal observation, a green light may represent a normal operation, and a blue light may mean that mandatory action is required.

With advances in technology, more colors may be made available as indicator lights. In some examples flashing lights may be used to signify a machine or process status. To communicate meanings of these new colors and/or patterns, a legend plate may be used to display the meaning directly next to each indicator light to give the operator guidance as to a meaning of (an illumination) of the indicator light.

### SUMMARY

Apparatus and associated methods relate to a light device with built-in status display. In an illustrative example, a multi-mode programmable indicator light (MPIL) may include at least one embedded programmable scrolling display (EPSD) at one or more light emitting portions (LEPs) of the MPIL. The LEP, for example, may emit a light indicium in a first plane orthogonal to a longitudinal axis of the MPIL. The EPSD, for example, may display a predetermined scrolling message at a physical peripheral boundary of the MPIL. The scrolling message, for example, may represent a corresponding predetermined interpretation of the light indicium. For example, the scrolling message may be displayed in a second plane substantially parallel to the first plane. Various embodiments may advantageously display an interpretation of the light indicium from substantially 360° around the longitudinal axis of the MPIL.

Apparatus and associated methods relate to a light device with a programmable display. In an illustrative example, a linear multi-mode programmable indicator light (LMPIL) may include a housing extending along a longitudinal axis having a display surface. For example, the LMPIL may include an indicator light, and a programmable display coupled to the housing. For example, the indicator light may emit a light indicium orthogonal to the display surface. For example, the programmable display may display a predetermined visual indicium along a longitudinal axis through the display surface when the indicator light emits the light indicium. For example, based on predetermined associations between light indicia and corresponding predetermined visual indicia, the programmable display may display the predetermined visual indicium as the corresponding predetermined interpretation of the light indicium based on the predetermined associations. Various embodiments may advantageously display preconfigured messages with corresponding light indicia on any visible surface.

Various embodiments may achieve one or more advantages. For example, some embodiments may display multiple messages at distinct portions of the MPIL to advantageously provide multiple messages simultaneously. Some embodiments, for example, may provide a 360° viewing angle without multiple legends around the MPIL. For example, some embodiments may include a user interface to advantageously provide an easy to program/reprogram the MPIL. Some embodiments, for example, may advantageously provide multiple combinations of a background color, a text color, characters height, and/or brightness of the EPSD to enhance color adaptability for color blind people. For example, some embodiments may include an encapsulating housing to advantageously protect the MPIL from (potentially) harsh operating environments. Some embodiments, for example, may be flexible to advantageously provide a peripheral optical boundary.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary multi-mode programmable indicator light (MPIL) employed in an illustrative use-case scenario.

FIG. 2 is a block diagram depicting an exemplary MPIL controller.

FIG. 3A and FIG. 3B depict exemplary embodiments of MPIL.

FIG. 3C depicts an exemplary cross-section view of an MPIL such as, for example, is depicted in FIG. 3B.

FIG. 4 is a flowchart illustrating an exemplary indicator light programming method.

FIG. 5 is a flowchart illustrating an exemplary indicator light operating method.

FIG. 6 is a block diagram depicting an exemplary MPIL in a linear form (LMPIL).

FIG. 7A, FIG. 7B, and FIG. 7C depict an exemplary embodiment of the LMPIL.

FIG. 8 is a flowchart illustrating an exemplary operating method to address multiple cascading MPIL.

Like reference symbols in the various drawings indicate like elements.

### DETAILED DESCRIPTION OF ILLUSTRATIVE EMBODIMENTS

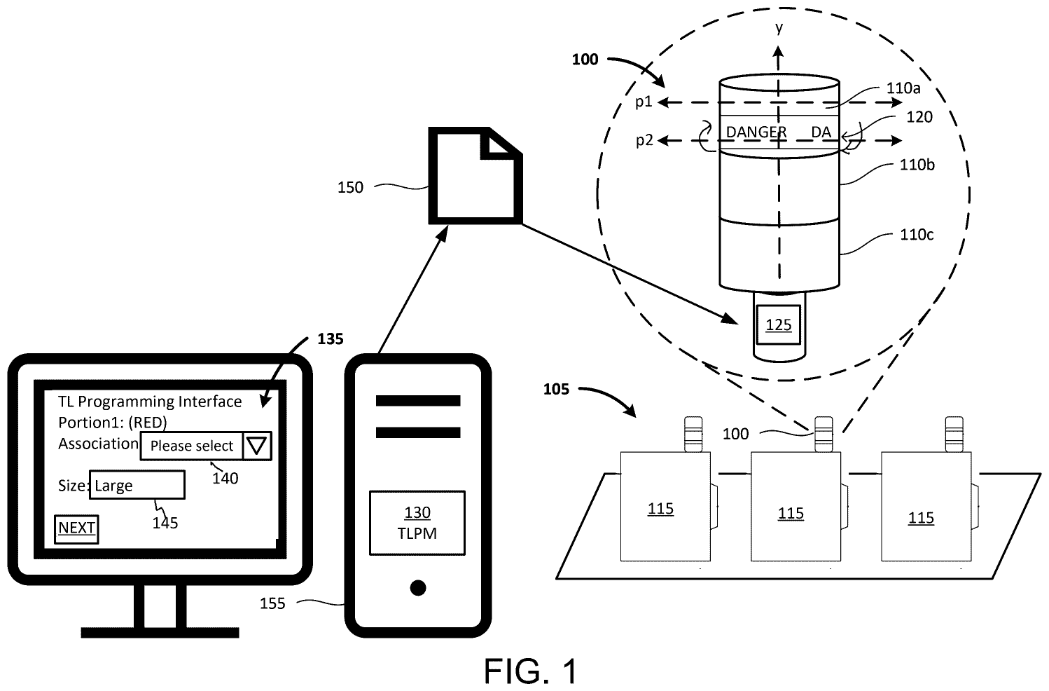

FIG. 1 depicts an exemplary Multi-mode Programmable Indicator Light (MPIL 100) employed in an illustrative use-case scenario. In the depicted example, a factory 105 includes multiple MPILs 100. For example, the MPILs 100 may be attached to machines 115 in the factory 105. For example, the lighting indicators may include a single or a multicolor indicator used to signify machine or process status (e.g., a factory tower light). Workers in the factory 105, for example, may read status signals transmitted by the MPILs 100 and interpret a status of the machines 115 (e.g., machines working in good condition, machines requiring maintenance, machines having safety issues). In some examples, each of the colors of the lighting indicators may, typically, be assigned a meaning for communicating and/or alerting a machine operator or floor supervisor.

As shown in a close-up diagram in FIG. 1, the MPIL 100 may include one or more light emitting portions (LEPs 110a, 110b, 110c). For example, each of the LEPs 110a-c may be a segment of a stacked tower light. For example, the top LEP 110a may be configured to display a red light. For example, the middle LEP 110b may be configured to display an amber light. For example, the bottom LEP 110c may be configured to display a green light. As shown, the MPIL 100 extends along a longitudinal axis y. In some implementations, the LEPs 110a-c may display a light 360° about the longitudinal axis y in a first plane p1.

In some implementations, the LEPs 110a-c may be a reconfigurable light emitting diode (LED) circuit. For example, the reconfigurable LED circuit may be reconfigured in size and color so that the LEPs 110a-c may be selectively varying in height and colors. In some examples, the MPILs 100 may be configured in a specific configuration that is controlled by a control signal connected to the MPIL 100. For example, the LEP 110a may be configured to be flashing red when a corresponding control signal is received by the MPIL 100.

In this example, the LEP 110a includes an embedded programmable scrolling display (EPSD 120). In some implementations, the EPSD 120 may be configured to display a text representing a meaning (of a color) of a corresponding LEP (e.g., the LEP 110a).

As shown, the EPSD 120 is configured to display a message indicating that the LEP 110a (e.g., a red lighting indicator) means “DANGER”. For example, the message may wrap around a perimeter of the LEP 110a. In some implementations, more than one message may be displayed at any of the LEPs 110a-c. For example, the message may be a repeating pattern distributed about the axis (e.g., the y-axis). For example, the LEP 110a may include one message at a base and another message at a top to advantageously provide multiple messages for each segment of the MPIL 100. In the depicted example, the message may be scrolling about the longitudinal axis y in a second plane p2. In some implementations, the planes p1 and p2 are coplanar. Accordingly, for example, the MPIL 100 may advantageously provide a 360° viewing angle without multiple legends around the multicolor MPIL 100.

In the depicted example, the MPIL 100 includes a MPIL controller 125. In some implementations, the MPIL 100 may include one or more RGB LEDs on a controlling circuit (e.g., a vertical printed circuit board (PCB)). For example, the RGB LEDs may be configured to display multiple color combinations controlled by the controller running a controlling software. In some implementations, by programming the MPIL controller 125, the LEPs may be configured to selectively display status messages corresponding to a color of the LEPs.

In this example, a user may use a computing device 155 to configure the MPIL 100. For example, the computing device 155 may be a desktop computer. For example, the computing device 155 may be a mobile computing device. In some examples, the computing device 155 may be a server accessed by a user device via a network (the Internet). The computing device 155 includes a tower light programming module (TLPM 130) in this example. For example, the TLPM 130 may be executed by the computing device 155 to program the MPIL 100. In this example, the TLPM 130 may display a user interface 135 for a user to selectively input a configuration to the MPIL 100.

In some implementations, the EPSD 120 may be programmed to display a message representing an interpretation of a corresponding LEP 110a-c. As shown, the user interface 135 may be used for programming a first portion (of red color light) of the MPIL 100. A user may select, from a drop-down menu 140, a predetermined message associated with the first portion (in red color light). For example, the predetermined message may be associated with a meaning of the LEP. In some examples, the predetermined message may be built-in to the TLPM 130. In some examples, new messages may be selectively added by a user via the user interface 135. In some implementations, various parameters associated with the meaning may be selected. For example, the message may be programmable through the user interface 135. As shown, a user may select a text size using a selection box 145. In some implementations, a user may use the TLPM 130 to configure a background color, a text color, characters height, and/or brightness of the EPSD 120. For example, the message may be static or scrolled at user selectable speeds. For example, messages in multiple languages may be displayed. Accordingly, the TLPM 130 may advantageously provide an easy to program/reprogram interface and enhance color adaptability for color blind people.

The TLPM 130, in some implementations, may generate a configuration data structure (CDS 150). In some implementations, the CDS 150 may include a configuration schema readable by the MPIL controller 125. For example, the configuration schema may include a mapping between, for example, a message and one or more of the LEPs. For example, the configuration schema may include a mapping between an input signal and a color and/or operating characteristics (e.g., animation, brightness) to one or more of the LEPs.

In the depicted example, the CDS 150 may be transmitted to the MPIL 100 to configure a display message at one or more of the LEPs 110a-c according to user input. For example, the CDS 150 may be flashed into a memory device (e.g., an onboard data register) of the MPIL 100. In some examples, the CDS 150 may be transmitted to the MPIL 100 via a network communication module (NCM) operably coupled to the MPIL controller 125 via a communication network. As an illustrative example, the NCM may be configured to interact with a Modbus network. In some examples, the NCM may be configured to interact with a Banner Bus network (as specified, for example, by Banner Engineering Corp., Plymouth, MN). In some examples, the NCM may be configured to interact with an IOLink Network.

In various implementations, the MPIL 100 may be extending along the y axis and defining a physical peripheral boundary path in a first plane p1 orthogonal to the y axis. For example, the MPIL 100 may emit a light indicium (e.g., a static light) corresponding to a predetermined interpretation in p1. The EPSD 120, for example, may be disposed along substantially a physical peripheral boundary path of the MPIL 100. For example, when the MPIL 100 emits the light indicium, the EPSD 120 may display at least one predetermined text message in a second plane p2 parallel to p1. For example, the at least one predetermined text message representing a corresponding predetermined interpretation of the light indicium so that the at least one visual indicium is visible in p2 from substantially 360° around the y axis.

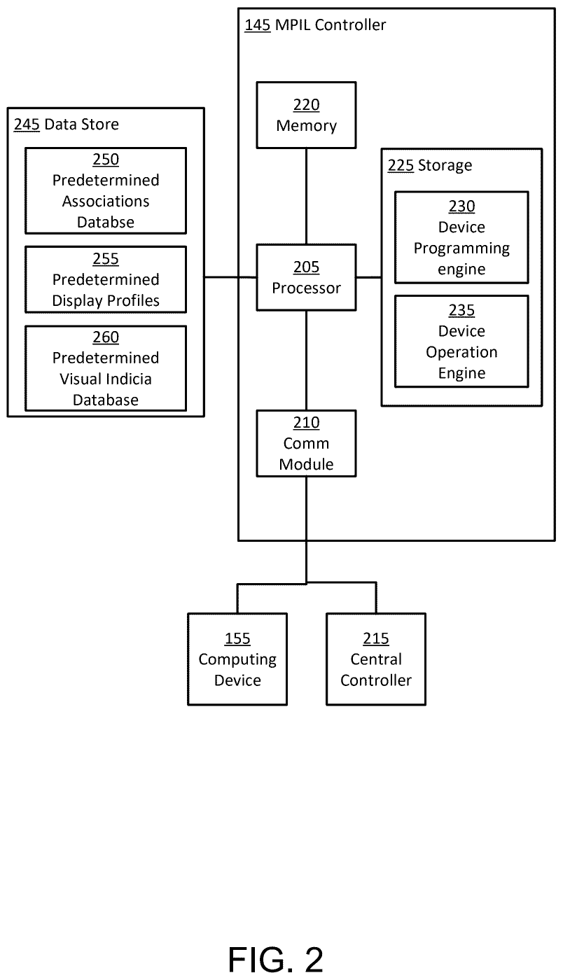

FIG. 2 is a block diagram depicting an exemplary MPIL controller 125. In the depicted example, the MPIL controller 125 includes a processor 205. The processor 205 may, for example, include one or more processing units. The processor 205 is operably coupled to a communication module 210. The communication module 210 may, for example, include wired communication.

The communication module 210 may, for example, include wireless communication. The communication module 210 may, for example, include MODBUS communication. In the depicted example, the communication module 210 is operably coupled to the computing device 155 and a central controller 215. The computing device 155, for example, may be configured to receive the CDS 150 transmitted to the communication module 210. The central controller, for example, may transmit a control signal to the MPIL 100 corresponding to status changes in the factory 105. For example, upon an emergency is detected, the central controller 215 may transmit a control signal to display an emergency light and at the MPIL 100.

The processor 205 is operably coupled to a memory module 220. The memory module 220 may, for example, include one or more memory modules (e.g., random-access memory (RAM)). The processor 205 includes a storage module 225. The storage module 225 may, for example, include one or more storage modules (e.g., non-volatile memory). In the depicted example, the storage module 225 includes a device programming engine (DPE 230) and a device operation engine (DOE 235).

The DPE 230 may, for example, process the CDS 150 received from the computing device 155. In some implementations, the DPE 230 may identify a mapping between a LEP (e.g., the LEPs 110a-c) and a corresponding visual indicium (e.g., text interpretation) based on the CDS 150. The DPE 230, for example, may retrieve the mapping and display the visual indicium with the corresponding LEP. In some examples, the DPE 230 may operate based on a control signal received from the central controller 215.

The processor 205 is further operably coupled to the data store 245. The data store 245, as depicted, includes a predetermined associations database 250, a predetermined display profiles 255, and a predetermined visual indicia database 260. In some implementations, the predetermined associations database 250 may store the predetermined association between various LEPs 110a-c and corresponding interpretations display (e.g., text). For example, after receiving the mapping, the DPE 230 may store associations indicated in the mapping in the predetermined associations database 250.

In some implementations, the predetermined display profiles 255 may include the display parameters of visual indicia at the LEPs 110a-c. For example, the display parameters may include the font size of a text message. For example, the display parameters may include a color of the text message. In some implementations, the display parameters may indicate display modes of a visual indicium. For example, the display profiles may include a stealth mode and an operation mode for a visual indicium. For example, in a stealth mode, the visual indicium may be configured as a solid color substantially the same as a color of a corresponding portion of the MPIL 100. For example, in an operation mode, the visual indicium may include a background different from the corresponding portion of the MPIL 100 and a scrolling text message.

The predetermined visual indicia database 260, for example, may include various visual indicia corresponding to the LEPs. For example, in operation, the DOE 235 may retrieve, from the predetermined visual indicia database 260, the visual indicium corresponds to a LEP. For example, the DOE 235 may display the retrieved visual indicium based on display parameters indicated in the predetermined display profiles 255 associated with the visual indicium.

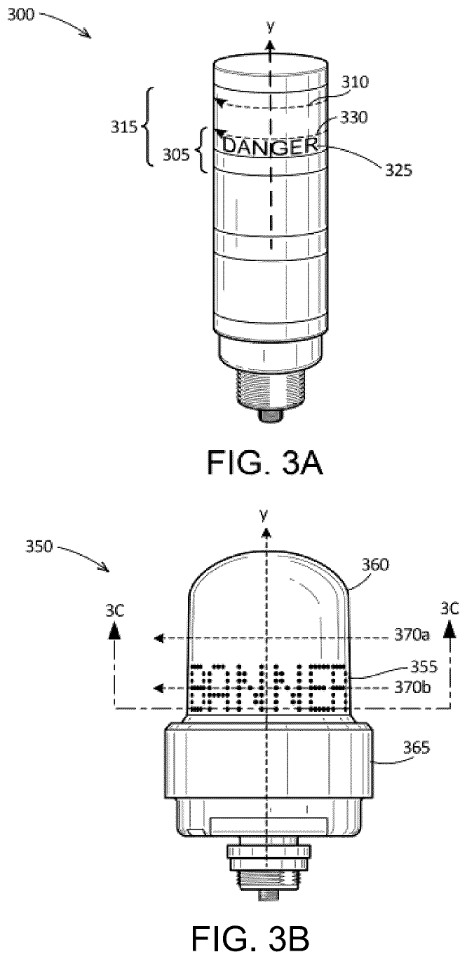

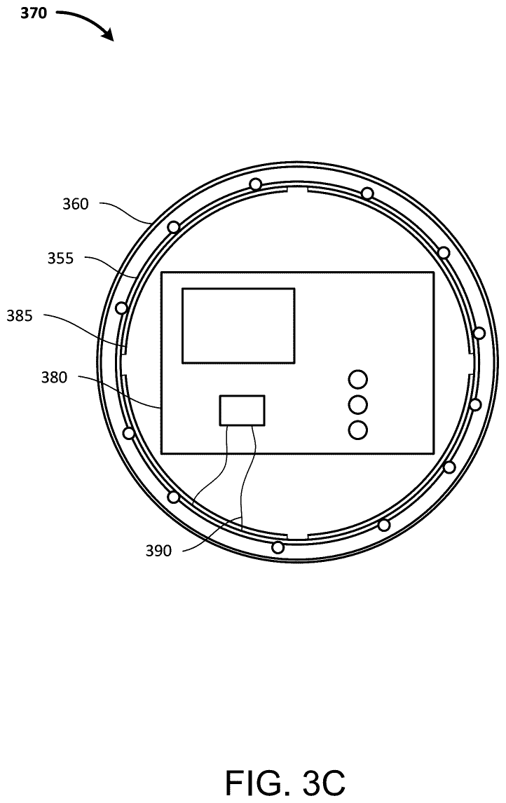

FIG. 3A and FIG. 3B depict exemplary embodiments of MPHIL. FIG. 3A shows an MPIL 300 with an EPSD 305 in a multi-color stack light application. As shown, the EPSD 305 includes a built-in image. In some implementations, the built-in image may be pre-installed in the MPIL 300. In some implementations, the built-in image may be user-programmable. For example, the MPIL 300 may include one message at the base or top of multiple messages (one for each segment).

As shown, the MPIL 300 may be extending along the y axis and defining a first peripheral boundary path 310 orthogonal to the y axis. In this example, the MPIL 300 emits a static light indicium (e.g., a red light) in a top LEP 315 of the MPIL 300. The EPSD 305 may display a text message 325 along substantially a second peripheral boundary path 330 of the MPIL 300. For example, the EPSD 305 may display the text message 325 in the second peripheral boundary path 330 parallel to a first peripheral boundary path 310. For example, the text message 325 may be visible along the second peripheral boundary path 330 from substantially 360° around the y axis. For example, the text message 325 may be a repeating pattern distributed about the axis (e.g., the y-axis).

FIG. 3B shows an MPIL 350 in a single indicator application with an EPSD 355. For example, the background and foreground colors of the MPIL 350 may be changed electrically by using RGB LEDs. In this example, the EPSD 355 includes a built-in image wrap around perimeters 370a, 370b of the MPIL 350. As shown, the perimeter 370a and the perimeter 370b may be parallel. For example, the perimeters 370a, 370b may be orthogonal to the y axis. For example, the built-in image displayed at the EPSD 355 may be scrolling. For example, the built-in image may be static.

In various implementations, the EPSDs 305, 355 may be fully configurable through software (e.g., the TLPM 130) including the background color, text color, character height, and brightness. In some examples, the EPSDs 305, 355 may be scrolled at user selectable speeds. In some implementations, multiple images may be stored and linked to individual inputs at a segment of the MPIL 300.

As shown in FIG. 3B, the EPSD 355 may, for example, be located inside an enclosure 360 with a lighting indicator of the MPIL 350. For example, the EPSD 355 may advantageously be protected from an outside environment (which may be harsh to the EPSD 355). In some examples, the MPIL 300 of FIG. 3A may also include a single housing encapsulating both the EPSD 305 and a RGB LED of the multicolor stack light.

As shown, the enclosure 360 may be coupled to a base housing 365. For example, the base housing 365 may include electrical and communication connections for the MPIL 350. As shown, the enclosure 360 extends substantially parallel to a physical peripheral boundary path of the EPSD 355. In some implementations, the enclosure 360 may be at least partially optically transparent. For example, the built-in image displayed at the EPSD 355 may be visible through the enclosure 360. In some implementations, the enclosure 360 may be configured to apply a predetermined optical effect to the built-in image and/or an indicator light within the MPIL 350.

FIG. 3C depicts an exemplary cross-section view 370 of an MPIL (e.g., the MPIL 350) such as, for example, is depicted in FIG. 3B. In the depicted example, the EPSD 355 is provided with individual light emitters 380 (e.g., LEDs). The individual light emitters 380 are electrically coupled, in the depicted example, to the EPSD 355. The EPSD 355 is coupled to a control circuit 385 by leads 395 (e.g., wire(s), bus(es), cable(s)). For example, the control circuit 385 may provide control signals and/or power to the individual light emitters 380 via the leads 395 and the EPSD 355.

As depicted, the EPSD 355 and the control circuit 385 are coupled (e.g., mounted) to a base element 390. The base element 390 may, for example, provide structure. In some implementations, the base element 390 may, for example, be a printed circuit board. For example, the control circuit 385 may be formed directly on the base element 390.

In the depicted example, the EPSD 355 is disposed around a periphery of the base element 390 such that the EPSD 355 is disposed around a peripheral boundary of the EPSD 355. In some implementations, by way of example and not limitation, the EPSD 355 may, for example, be rigidly formed into the shape of the periphery. In some implementations, by way of example and not limitation, the EPSD 355 may, for example, be jointed (e.g., multi-segmented) such that the EPSD 355 may be disposed around the periphery. The EPSD 355 may, in some examples, be flexible (e.g., a flex circuit having at least one flexible substrate such that it may be manually manipulated into a range of desired curvilinear shapes). Accordingly, the EPSD 355 may advantageously provide a peripheral optical boundary. For example, the EPSD 355 may be at least partially opaque.

In the depicted example, the enclosure 360 is disposed around the outside of the EPSD 355. The enclosure 360 may, for example, be optically translucent. In some implementations, the enclosure 360 may apply one or more optical effects (e.g., increased refraction and/or reflection, frequency filtering).

In some implementations, one or more light-emitting modules (e.g., bulbs, LEDs) may be disposed above the EPSD 355 relative to the longitudinal axis. In some implementations, one or more light emitting modules may be disposed interior to the EPSD 355 but configured such that the light is emitted above and/or below the EPSD 355 relative to the longitudinal axis. In some such implementations, the EPSD 355 may provide, for example, a dynamic interpretation of the light displayed longitudinally adjacent to the EPSD 355.

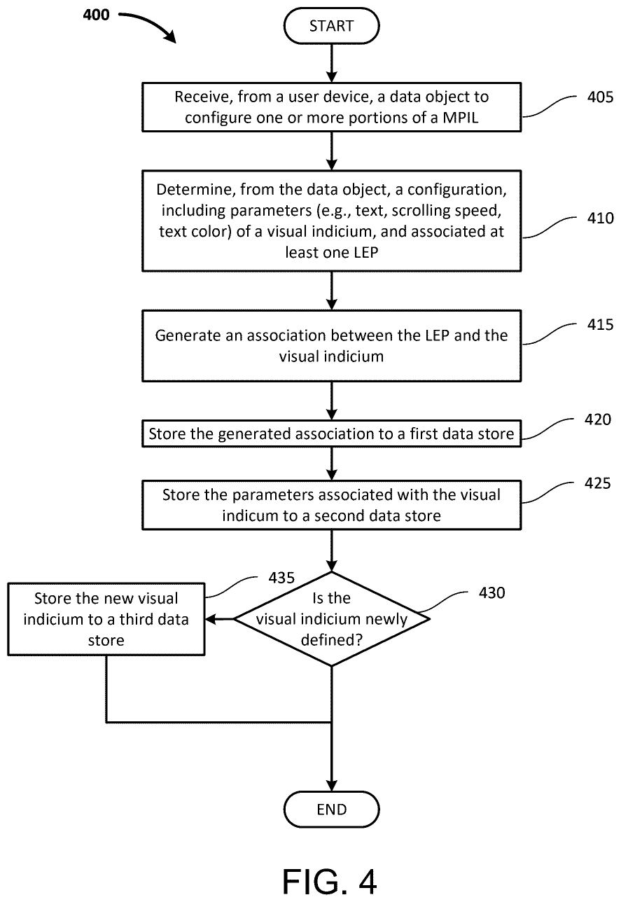

FIG. 4 is a flowchart illustrating an exemplary indicator light programming method 400. For example, the DPE 230 may perform the method 400 to associate various predetermined visual indicia to a corresponding LEP of a MPIL. The method 400 begins in step 405 when a data object to configure one or more portions of a MPIL is received from a user device. For example, the MPIL controller 125 may receive the CDS 150 from the computing device 155. Next, in step 410, a configuration, including parameters (e.g., text, scrolling speed, text color) of a visual indicium, and associated at least one LEP, is determined from the data object. In step 415, an association between the LEP and the visual indicium is generated. After the association is generated, in step 420, the generated association is stored in a first datastore (e.g., the predetermined associations database 250). In step 425, the parameters associated with the visual indicium are stored in a second data store (e.g., the predetermined display profiles).

In a decision point 430, it is determined whether the visual indicium is newly defined. For example, the visual indium may be a new meaning of the LEP defined by a user. If it is determined whether the visual indicium is not newly defined, the method 400 ends. If it is determined whether the visual indicium is newly defined, in step 435, the new visual indicium is stored to a third data store (e.g., the predetermined visual indicia database) and the method 400 ends.

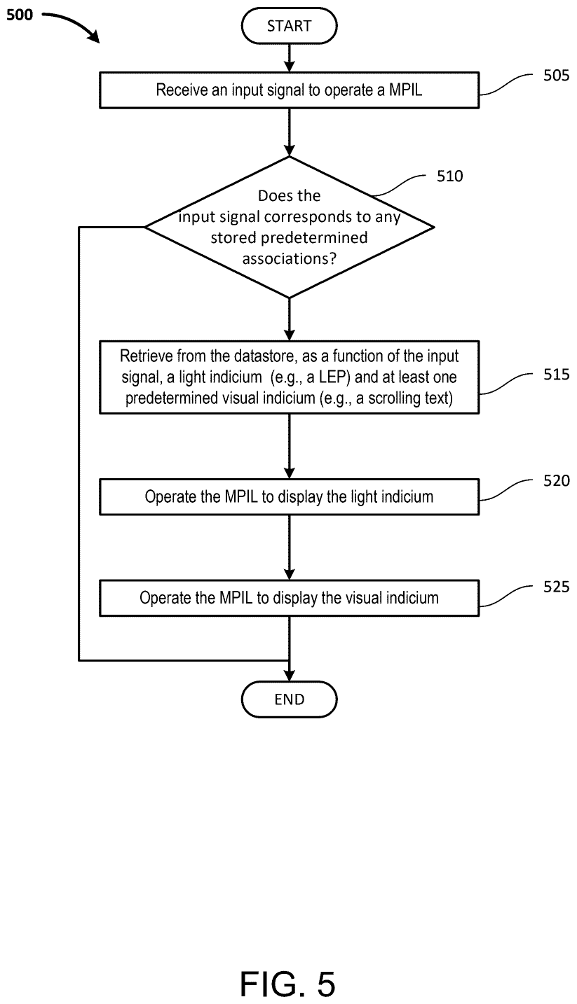

FIG. 5 is a flowchart illustrating an exemplary indicator light operating method 500. For example, the DOE 235 may use the method 500 to control the MPIL 100 in operation. The method 500 begins when an input signal is received to operate a MPIL in step 505. For example, a control signal is received from the central controller 215. In a decision point 510, it is determined whether the input signal corresponds to any stored predetermined associations. For example, the predetermined associations database 250 may include a mapping between input signals and corresponding display of the MPIL 100. If the input signal does not correspond to any stored predetermined association, the method 500 ends.

If the input signal corresponds to a stored predetermined association, in step 515, a light indicium (e.g., a LEP) and at least one predetermined visual indicium (e.g., a scrolling text) is retrieved as a function of the input signal from the data store. In step 520, the MPIL is operated to display the light indicium. For example, the DOE 235 may retrieve a color associated with the input signal from the predetermined display profiles 255. In step 525, the MPIL is operated to display the visual indicium, and the method 500 ends. For example, the DOE 235 may retrieve, from the predetermined visual indicia database, a corresponding text message to be displayed associated with the light indicium.

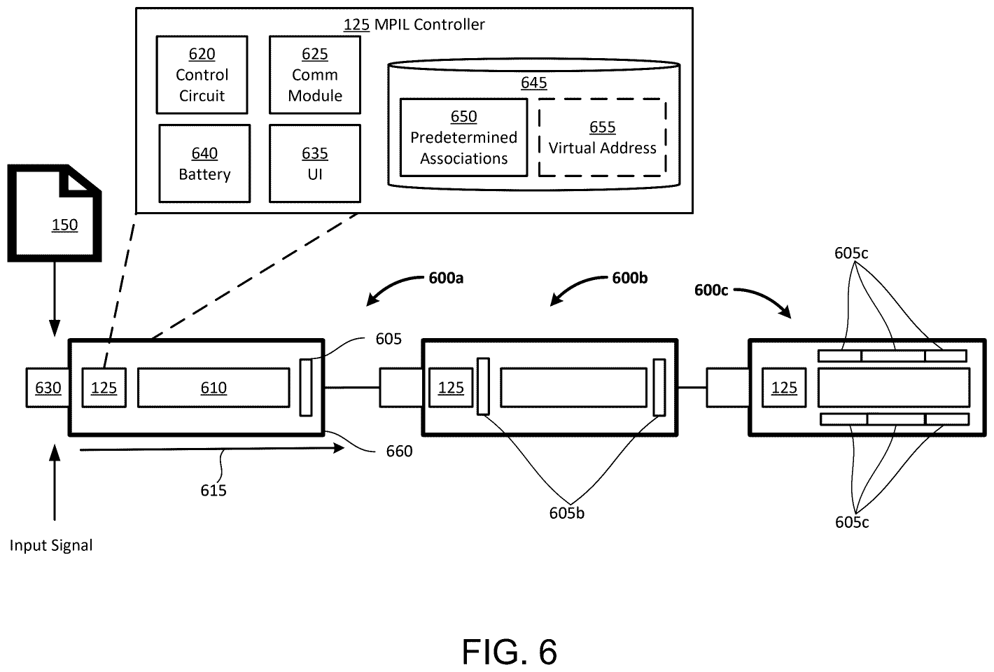

FIG. 6 is a block diagram depicting an exemplary MPIL in a linear form (LMPIL). In the depicted example, a LMPIL 600a includes an indicator light 605 and an EPSD 610. For example, the EPSD 610 may include the EPSD 120 embedded in the LMPIL 600a in a linear format (e.g., instead of being circularly wrapped around the y-axis as described with reference to FIG. 1). In this example, the EPSD 610 extends on the LMPIL 600a along a longitudinal axis 615.

In this example, the LMPIL 600a includes the MPIL controller 125. The MPIL controller 125, for example, includes a control circuit 620 and a communication module 625. For example, the control circuit 620 may be configured to control the EPSD 610, and the indicator light 605 based on signal received through the communication module 625 from an input port 630. For example, the input port 630 may receive wired signals. In some implementations, the input port 630 may receive a wireless signal. For example, the communication module 625 may be configured to process wireless radio signals. For example, the communication module 625 may be configured to process wireless fidelity (WIFI) signals. For example, the communication module 625 may be configured to process Bluetooth signals. In various implementations, the EPSD 120 may control the indicator light 605 and the EPSD 610 based on the CDS 150 received as described with reference to FIGS. 1-5.

The MPIL controller 125, in this example, includes a user interface (UI 635). For example, the UI 635 may be configured to receive a user (configuration) input. In some implementations, the UI 635 may include a button on one end of the LMPIL 600a. For example, a user may configure the LMPIL 600a using the UI 635 to synchronize the communication module 625 (e.g., a predetermined channel, a predetermined frequency) of radio signals.

The LMPIL 600a, for example, may be powered by a battery 640. For example, the battery 640 may advantageously allow the LMPIL 600a to operate wirelessly in areas and/or surfaces that are difficult to obtain wired power.

As shown, the indicator light 605 is disposed on one end of the LMPIL 600a. In some implementations, the indicator light 605 may be disposed at other positions of the LMPIL 600a. For example, in this example, the LMPIL 600a is connected to some other embodiments of the LMPIL. For example, a LMPIL 600b connected serially to the LMPIL 600a may include indicator lights 605b on both ends of the LMPIL 600b. In some implementations, each of the indicator lights 605b of the LMPIL 600b may be independently controlled. For example, the indicator lights 605b may be controlled to emit a different color of light. For example, the indicator lights 605b may be controlled to emit light asynchronously. For example, the indicator lights 605b may be controlled to emit light in different light patterns.

In this example, a LMPIL 600c is serially connected to the LMPIL 600b. For example, the LMPIL 600c includes the indicator lights 605c along a (e.g. longitudinal, vertical) length of the LMPIL 600c. In some examples, the LMPIL 600c may control each (e.g., user-defined, predefined) portion of the indicator lights 605c independently (e.g., color, timing, pattern).

In some implementations, the control circuit 620 may be configured to control various sections of the EPSD 610 by (e.g., virtual, physical) address predefined by in the MPIL controller 125. For example, the various sections may be pre-configured during installation (e.g., by an engineer). In some implementations, in a configuration operation, the MPIL controller 125 of one of the LMPIL 600a, the LMPIL 600b, and the LMPIL 600c may include one or more virtual addresses that span (e.g., extend) across adjacent EPSD 610.

In this example, the MPIL controller 125 and/or the EPSD 610, and the indicator light 605 of the LMPIL 600a are coupled to an indicator housing 660. For example, the MPIL controller 125 and/or the EPSD 610 may be enclosed within the indicator housing 660. The indicator housing 660, for example, may include a front surface configured to allow visual indicium emitted from the EPSD 610 to pass through. In some implementations, the indicator light 605 may be coupled to the front surface of the indicator housing 660. In other implementations, the indicator light 605 may also be enclosed within the indicator housing 660.

As shown, the indicator housing 660 extends along the longitudinal axis 615. For example, the indicator housing 660 may include synthetic materials. For example, the indicator housing 660 may include plastic (e.g., like polycarbonate or Acrylonitrile Butadiene Styrene (ABS)). For example, the indicator housing 660 may include metal (e.g., aluminum or stainless steel). For example, the indicator housing 660 may include composite materials. In some embodiments, the indicator housing 660 may be dust-tight. In some embodiments, the indicator housing 660 may be water-resistant. Various embodiments may advantageously allow the LMPIL 600a to be operable in harsh environments (e.g., in a food processing industry, in a recycling plant).

The MPIL controller 125 includes a datastore 645 in this example. For example, the datastore 645 may be configured to store predetermined associations 650 between light indicia and corresponding predetermined visual indicia. For example, the predetermined associations 650 may be configurable by the CDS 150. In some implementations, the control circuit 620 may be configured to perform the method 500. For example, the control circuit 620 may be configured to perform the decision point 510 by accessing the datastore 645. For example, in response to the input signal received at the input port 630, the indicator light 605 may display a light indicium (e.g., a color of light, an activation of light, a light pattern) as a function of the input signal. For example, the EPSD 610 may display the at least one predetermined visual indicium as the corresponding predetermined interpretation of the light indicium based on the predetermined associations 650 stored in the datastore 645.

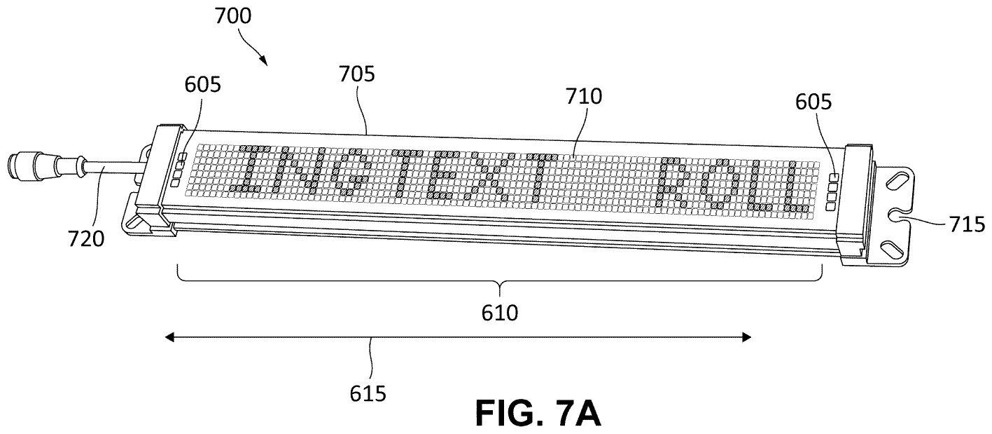

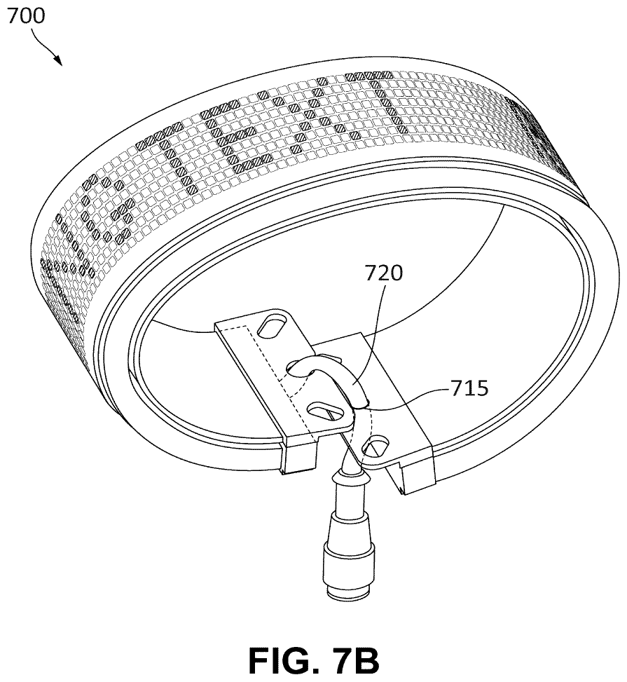

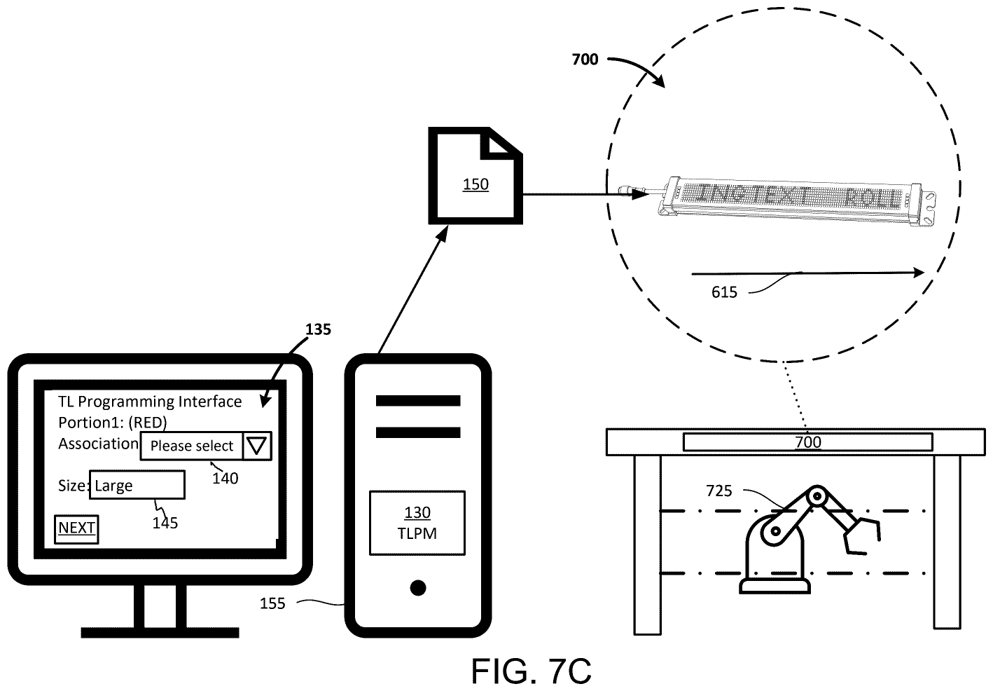

FIG. 7A, FIG. 7B, and FIG. 7C depict an exemplary embodiment of the LMPIL. In the depicted example as shown in FIG. 7A, a LMPIL 700 includes a housing 705 (e.g., the indicator housing 660). In some implementations, the housing 705 may include a front surface (e.g., a display surface 710) and a back surface (not shown). For example, the display surface 710 may include a transparent smoky black material. For example, the display surface 710 may hide internal components (e.g., circuitry, integrated circuit (IC)) enclosed within the housing 705.

In this example, the EPSD 610 may be coupled to the housing 705. For example, the EPSD 610 may be disposed along the longitudinal axis 615. As shown, the EPSD 610 may display a scrolling text in any one of two directions of the longitudinal axis 615. For example, the EPSD 610 may display a predetermined visual indicium through the display surface 710 (e.g., based on a signal generated by the control circuit 620). In some implementations, a text displayed by the EPSD 610 may include one color. In some implementations, the text may include multiple colors (e.g., a full RGB).

In some embodiments, when the indicator light 605 emits a light indicium, the control circuit 620 may generate the signal to control the EPSD 610 to display an associated visual indicium based on the predetermined associations 650 (FIG. 6). For example, the predetermined associations 650 may be determined based on a corresponding predetermined interpretation of the light indicium displayed by the indicator light 605. For example, the indicator light 605 and the EPSD 610 may emit light indicia orthogonal to the display surface 710.

In some implementations, the indicator housing 660 may be bendable (e.g., as shown in FIG. 7B). For example, the MPIL controller 125 may include a flex circuit. The LMPIL 700 includes a key slot 715 at one end of the housing 705. For example, the key slot 715 may releasably couple to an input cable 720 (e.g., a key) on an opposite end of the housing 705 along the longitudinal axis 615. For example, the input cable 720 may extend along the longitudinal axis 615 out of the housing 705. As shown in FIG. 7B, the LMPIL 700 may be configured to be releasably fixated in a bend position by coupling the input cable 720 and the key slot 715 together.

In some embodiments, the housing 705 may include the input cable 720 extending out of both ends of the housing 705. For example, the housing 705 may include matching key slot 715 on both ends of the housing 705. For example, the key slot 715 and the input cable 720 may be configured to serially (e.g., cascadingly) couple adjacent LMPIL 700. For example, the cascading devices may be referenced by a controller (coupled to the LMPIL 700 to generate an input signal) by a virtual address system (e.g. a Modbus® system). Modbus is a registered trademark of Schneider Electric SE headquartered in Paris, France. In some examples, virtual addresses 655 may be stored in the datastore 645. For example, the virtual addresses 655 may be stored as a lookup table in the datastore 645.

As shown in FIG. 7C, the LMPIL 700 is used in an illustrative scenario. As shown, the LMPIL 700 may be embedded on a gate enclosing a robotic arm 725. For example, the LMPIL 700 may display in the EPSD 610 a status message corresponding to the indicator light 605. As an illustrative example without limitation, the status message may indicate that it is dangerous to enter the area (e.g., because the robotic arm 725 is operating).

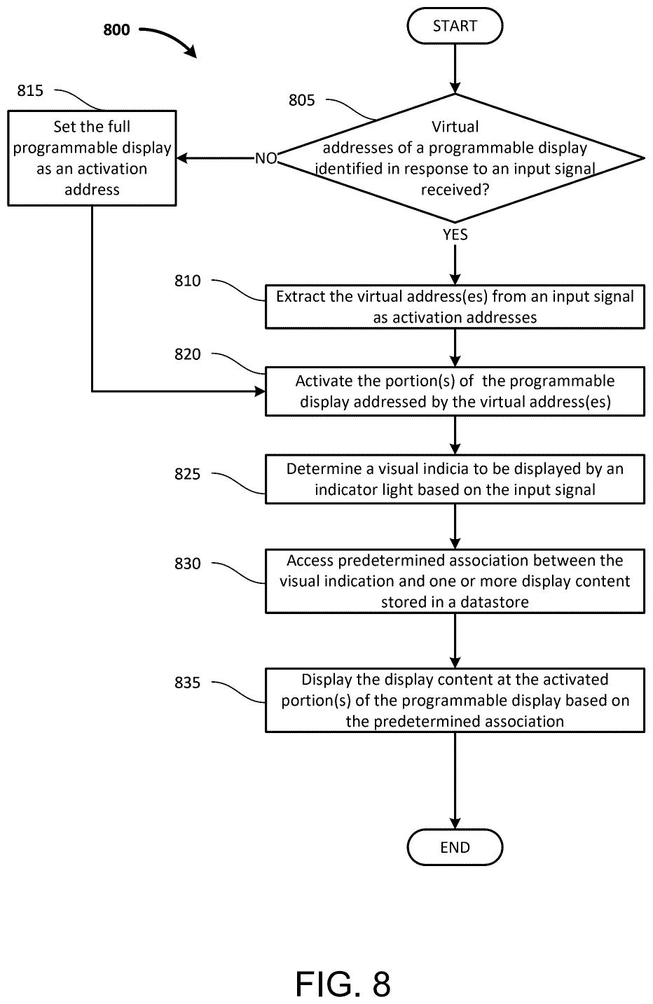

FIG. 8 is a flowchart illustrating an exemplary operating method to address multiple cascading MPIL. For example, a method 800 may be performed by the control circuit 620 (e.g., of the MPIL controller 125). In the depicted example, the method 800 begins in a decision point 805 when it is determined whether virtual addresses of a programmable display have been identified in response to an input signal. For example, the control circuit 620 may receive an input signal through the communication module 625. For example, the control circuit 620 may check whether the input signal includes at least one virtual address associated with one or more portions of the EPSD 610.

If virtual addresses are identified, in step 810, corresponding virtual addresses are extracted from the input signal as activation address(es). For example, the control circuit 620 may retrieve a virtual address mapping (e.g., a lookup table, the virtual addresses 655 stored in the datastore 645) to determine virtual addresses that correspond to sections of the programmable display. If no virtual addresses are identified, the full programmable display is set as an activation address in step 815. For example, the control circuit 620 may activate the EPSD 610 entirely to display a visual message, for example, based on the input signal.

After the step 810 or the step 815, the portions of the programmable display addressed by the activation addresses are activated in step 820. For example, the control circuit 620 may selectively activate the sections of the EPSD 610 that correspond to the extracted virtual addresses.

Next, in step 825, it is determined what visual indicium should be displayed by the indicator light based on the input signal. For example, the control circuit 620 may access a mapping between input signals and corresponding visual indicia stored in the datastore 645. For example, the corresponding visual indicia may be emitted by the indicator light 605. For example, the corresponding visual indicia may be emitted by the LEP 110a, the LEP 110b, and/or the LEPs 110c

In step 830, a predetermined association between the visual indication and one or more display content stored in a datastore is accessed. For example, the control circuit 620 may retrieve the predetermined associations 650 from the datastore 645. For example, the display content may include a scrolling text. For example, the display content may include emoticons. For example, the display content may include image(s). In step 835, the display content is displayed at the activated portions of the programmable display based on the predetermined association, and the method 800 ends. For example, the control circuit 620 may instruct the EPSD 610 to display the corresponding visual indicium in the activated sections of the programmable display.

Although various embodiments have been described with reference to the figures, other embodiments are possible. In some implementations, the virtual address indicated in the input signal may identify a first continuous portion of a first indicator light and a second continuous portion of a second indicator light. As an illustrative example without limitation, a distal end of the first indicator light (e.g., the LMPIL 600a) may be coupled to a proximal end of the second indicator light (e.g., the LMPIL 600b). In some examples, the first continuous portion and the second continuous portion are located adjacent to each other.

Although an exemplary system has been described with reference to FIG. 1, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In an illustrative aspect, an indicator apparatus may include an indicator light housing extending along a longitudinal axis. For example, the indicator light housing may include a display surface. For example, the indicator light housing may be bendable. For example, the indicator light housing may include a slot at one end of the indicator light housing along the longitudinal axis. For example, the slot may be configured to releasably couple to a key object.

For example, the indicator apparatus may include at least one indicator light coupled to the indicator light housing. For example, the at least one indicator light may be configured to emit a light indicium orthogonal to the display surface. For example, the indicator apparatus may include a programmable lighting array coupled to the indicator light housing and disposed along the longitudinal axis. For example, the programmable lighting array may be configured such that, when the at least one indicator light emits the light indicium, the programmable lighting array may display at least one predetermined visual indicium through the display surface. For example, the at least one predetermined visual indicium represents a corresponding predetermined interpretation of the light indicium.

For example, the indicator apparatus may include a datastore operably configured to store a plurality of predetermined associations between light indicia and corresponding predetermined visual indicia. For example, in response to an input signal received at an input port, the at least one indicator light may be configured to display the light indicium as a function of the input signal, and the programmable lighting array may be configured to display the at least one predetermined visual indicium as the corresponding predetermined interpretation of the light indicium based on the plurality of predetermined associations stored in the datastore.

The indicator apparatus, for example, may include a controller operably coupled to the at least one indicator light and the programmable lighting array. For example, the controller may be configured to perform indication operations in response to the input signal. For example, the indication operations may include retrieve from the datastore, as a function of the input signal, the light indicium and the at least one predetermined visual indicium. For example, the indication operations may include operating the at least one indicator light to display the light indicium. For example, the indication operations may include operating the programmable lighting array to display the at least one predetermined visual indicium as the corresponding predetermined interpretation of the light indicium.

For example, the at least one indicator light may include a plurality of indicator lights disposed along the longitudinal axis. For example, the plurality of indicator lights may include a first light, and a second light disposed on each end of the indicator light housing. For example, the plurality of indicator lights may be configured to emit a light indicium independently based on the input signal.

For example, the display surface may include a dark transparent surface configured to hide circuitry from view when the at least one light indicator and the programmable lighting array may be deactivated. For example, the programmable lighting array may include a plurality of sub-sections. For example, each of the plurality of sub-sections may be addressable individually through a virtual address defined in the datastore. For example, the programmable lighting array may be configured to display, as a function of the input signal, more than a plurality of the at least one predetermined visual indicium simultaneously the plurality of sub-sections.

For example, the key object may include a data cable extending along the longitudinal axis from another end of the indicator light housing, such that the indicator light housing is releasably fixated in a bend position by coupling the data cable and the slot together.

In an illustrative aspect, an indicator apparatus may include an indicator light housing extending along a longitudinal axis may include a display surface. For example, the indication operations may include at least one indicator light coupled to the indicator light housing. For example, the at least one indicator light may be configured to emit a light indicium orthogonal to the display surface.

For example, the indication operations may include a programmable lighting array coupled to the indicator light housing and disposed along the longitudinal axis. For example, the programmable lighting array may be configured such that, when the at least one indicator light emits the light indicium, the programmable lighting array may display at least one predetermined visual indicium through the display surface. For example, the at least one predetermined visual indicium represents a corresponding predetermined interpretation of the light indicium.

For example, the indication operations may include a datastore operably configured to store a plurality of predetermined associations between light indicia and corresponding predetermined visual indicia. For example, in response to an input signal received at an input port, the at least one indicator light may be configured to display the light indicium as a function of the input signal, and the programmable lighting array may be configured to display the at least one predetermined visual indicium as the corresponding predetermined interpretation of the light indicium based on the plurality of predetermined associations stored in the datastore.

The indicator apparatus, for example, may include a controller operably coupled to the at least one indicator light and the programmable lighting array. For example, the controller may be configured to perform indication operations in response to the input signal. For example, the indication operations may include retrieve from the datastore, as a function of the input signal, the light indicium and the at least one predetermined visual indicium. For example, the indication operations may include operating the at least one indicator light to display the light indicium. For example, the indication operations may include operating the programmable lighting array to display the at least one predetermined visual indicium as the corresponding predetermined interpretation of the light indicium.

For example, the at least one indicator light may include a plurality of indicator lights disposed along the longitudinal axis.

For example, the plurality of indicator lights may include a first light, and a second light disposed on each end of the indicator light housing.

For example, the plurality of indicator lights may be configured to emit a light indicium independently based on the input signal.

For example, the display surface may include a dark transparent surface configured to hide circuitry from view when the at least one light indicator and the programmable lighting array may be deactivated.

For example, the programmable lighting array may include a plurality of sub-sections. For example, each of the plurality of sub-sections may be addressable individually through a virtual address defined in the datastore. For example, the programmable lighting array may be configured to display, as a function of the input signal, more than a plurality of the at least one predetermined visual indicium simultaneously the plurality of sub-sections.

The indicator apparatus, for example, may include a data cable extending along the longitudinal axis from one end of the indicator light housing and a slot. For example, the indicator light housing may be bendable, and the slot may be configured to releasably fixate the indicator light housing in a bend position.

A status display system may include a plurality of the indicator apparatus. For example, the plurality of the indicator apparatus may be releasably coupled by coupling the data cable of a first indicator apparatus to a slot of a second indicator apparatus.

For example, the plurality of the indicator apparatus may be operably coupled serially via a data cable connection. For example, each of the plurality of the indicator apparatus may be individually addressable through a virtual address system.

In an illustrative aspect, an indicator light operation method may include, in response to receiving an input signal, extract at least one virtual address from the input signal. For example, the at least one virtual address corresponds to one of a plurality of continuous portions of a programmable display array of an indicator light may include the programmable display and a light emitting portion.

For example, the indicator light operation method may include activating at least one of the plurality of continuous portions of the programmable display based on the at least one virtual address.

For example, the indicator light operation method may include determining a visual indicium to be emitted by the light emitting portion as a function of the input signal.

For example, the indicator light operation method may include retrieving, from a datastore, a predetermined association between the visual indicium and at least one display content for each at least one activated continuous portion. For example, the at least one display content may include a corresponding predetermined interpretation of the light indicium.

For example, the indicator light operation method may include display the at least one display content for each at least one activated continuous portion.

For example, the at least one virtual address may include a first continuous portion of a first indicator light and a second continuous portion of a second indicator light. For example, a distal end of the first indicator light may be coupled to a proximal end of the second indicator light. For example, the first continuous portion and the second continuous portion may be located adjacent to each other.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An indicator apparatus comprising:
an indicator light housing extending along a longitudinal axis comprising a display surface, wherein the indicator light housing is bendable, and comprises a slot at one end of the indicator light housing along the longitudinal axis, wherein the slot is configured to releasably couple to a key object; and,
at least one indicator light coupled to the indicator light housing, wherein the at least one indicator light is configured to emit a light indicium orthogonal to the display surface;
a programmable lighting array coupled to the indicator light housing and disposed along the longitudinal axis, wherein the programmable lighting array is configured such that, when the at least one indicator light emits the light indicium, the programmable lighting array displays at least one predetermined visual indicium through the display surface, wherein the at least one predetermined visual indicium represents a corresponding predetermined interpretation of the light indicium; and,
a datastore operably configured to store a plurality of predetermined associations between light indicia and corresponding predetermined visual indicia, wherein, in response to an input signal received at an input port, the at least one indicator light is configured to display the light indicium as a function of the input signal, and the programmable lighting array is configured to display the at least one predetermined visual indicium as the corresponding predetermined interpretation of the light indicium based on the plurality of predetermined associations stored in the datastore.

2. The indicator apparatus of claim 1, further comprises a controller operably coupled to the at least one indicator light and the programmable lighting array, wherein the controller is configured to perform indication operations in response to the input signal, the indication operations comprises:
retrieve from the datastore, as a function of the input signal, the light indicium and the at least one predetermined visual indicium;
operate the at least one indicator light to display the light indicium; and,
operate the programmable lighting array to display the at least one predetermined visual indicium as the corresponding predetermined interpretation of the light indicium.

3. The indicator apparatus of claim 1, wherein the at least one indicator light comprises a plurality of indicator lights disposed along the longitudinal axis.

4. The indicator apparatus of claim 3, wherein the plurality of indicator lights comprises a first light and a second light disposed on each end of the indicator light housing.

5. The indicator apparatus of claim 3, wherein the plurality of indicator lights are configured to emit a light indicium independently based on the input signal.

6. The indicator apparatus of claim 1, wherein the display surface comprises a dark transparent surface configured to hide circuitry from view when the at least one light indicator and the programmable lighting array are deactivated.

7. The indicator apparatus of claim 1, wherein the programmable lighting array comprises a plurality of sub-sections, wherein each of the plurality of sub-sections is addressable individually through a virtual address defined in the datastore, such that the programmable lighting array is configured to display, as a function of the input signal, more than a plurality of the at least one predetermined visual indicium simultaneously the plurality of sub-sections.

8. The indicator apparatus of claim 1, wherein the key object comprises a data cable extending along the longitudinal axis from another end of the indicator light housing, such that the indicator light housing is releasably fixated in a bend position by coupling the data cable and the slot together.

9. An indicator apparatus comprising:
an indicator light housing extending along a longitudinal axis comprising a display surface;
at least one indicator light coupled to the indicator light housing, wherein the at least one indicator light is configured to emit a light indicium orthogonal to the display surface;
a programmable lighting array coupled to the indicator light housing and disposed along the longitudinal axis, wherein the programmable lighting array is configured such that, when the at least one indicator light emits the light indicium, the programmable lighting array displays at least one predetermined visual indicium through the display surface, wherein the at least one predetermined visual indicium represents a corresponding predetermined interpretation of the light indicium; and,
a datastore operably configured to store a plurality of predetermined associations between light indicia and corresponding predetermined visual indicia, wherein, in response to an input signal received at an input port, the at least one indicator light is configured to display the light indicium as a function of the input signal, and the programmable lighting array is configured to display the at least one predetermined visual indicium as the corresponding predetermined interpretation of the light indicium based on the plurality of predetermined associations stored in the datastore.

10. The indicator apparatus of claim 9, further comprises a controller operably coupled to the at least one indicator light and the programmable lighting array, wherein the controller is configured to perform indication operations in response to the input signal, the indication operations comprises:
retrieve from the datastore, as a function of the input signal, the light indicium and the at least one predetermined visual indicium;
operate the at least one indicator light to display the light indicium; and,
operate the programmable lighting array to display the at least one predetermined visual indicium as the corresponding predetermined interpretation of the light indicium.

11. The indicator apparatus of claim 9, wherein the at least one indicator light comprises a plurality of indicator lights disposed along the longitudinal axis.

12. The indicator apparatus of claim 11, wherein the plurality of indicator lights comprises a first light and a second light disposed on each end of the indicator light housing.

13. The indicator apparatus of claim 11, wherein the plurality of indicator lights are configured to emit a light indicium independently based on the input signal.

14. The indicator apparatus of claim 9, wherein the display surface comprises a dark transparent surface configured to hide circuitry from view when the at least one light indicator and the programmable lighting array are deactivated.

15. The indicator apparatus of claim 9, wherein the programmable lighting array comprises a plurality of sub-sections, wherein each of the plurality of sub-sections is addressable individually through a virtual address defined in the datastore, such that the programmable lighting array is configured to display, as a function of the input signal, more than a plurality of the at least one predetermined visual indicium simultaneously the plurality of sub-sections.

16. The indicator apparatus of claim 9, further comprises a data cable extending along the longitudinal axis from one end of the indicator light housing and a slot, wherein the indicator light housing is bendable, and the slot is configured to releasably fixate the indicator light housing in a bend position.

17. A status display system comprises a plurality of the indicator apparatus of claim 16, wherein the plurality of the indicator apparatus are releasably coupled by coupling the data cable of a first indicator apparatus to a slot of a second indicator apparatus.

18. The status display system of claim 17, wherein the plurality of the indicator apparatus are operably coupled serially via a data cable connection, wherein each of the plurality of the indicator apparatus is individually addressable through a virtual address system.

19. An indicator light operation method, comprising:
in response to receive an input signal, extract at least one virtual address from the input signal, wherein the at least one virtual address corresponds to one of a plurality of continuous portions of a programmable display array of an indicator light comprising the programmable display and a light emitting portion;
activate at least one of the plurality of continuous portions of the programmable display based on the at least one virtual address;
determine a visual indicium to be emitted by the light emitting portion as a function of the input signal;
retrieve, from a datastore, a predetermined association between the visual indicium and at least one display content for each at least one activated continuous portion, wherein the at least one display content comprises a corresponding predetermined interpretation of the light indicium; and,
display the at least one display content for each at least one activated continuous portion.

20. The indicator light operation method of claim 19, wherein the at least one virtual address comprises a first continuous portion of a first indicator light and a second continuous portion of a second indicator light, wherein a distal end of the first indicator light is coupled to a proximal end of the second indicator light, such that the first continuous portion and the second continuous portion are located adjacent to each other.
